(19) United States
(12) Patent Application Publication
(10) Pub. No.: US 2006/0075134 A1
(43) Pub. Date: Apr. 6, 2006

(54) Routing data packets in a compressed-header domain

(76) Inventors: Mika Aalto, Espoo (FI); Vilho Raisainen, Nelsink (FI)

Correspondence Address: ROBERT M BAUER, ESQ.;LACKENBACH SIEGEL, LLP, 1 CHASE ROAD, SCARSDALE, NY, 10583, US

(21) Appl. No.: 10/529,195

(22) PCT Filed: Sep. 30, 2002
(86) PCT No.: PCT/IB02/04002

§ 371 Date: Mar. 24, 2005

(51) Int. Cl. G06F 15/173

(52) U.S. Cl. 709/238

(57) ABSTRACT

The invention concerns routing of data packets in a header-compressed domain. According to the method described, routing a data packet with a compressed header section and an uncompressed payload section comprises steps of receiving the data packet at an ingress interface, routing the data packet to an egress interface, and forwarding the data packet to the egress interface. According to this method, the compressed header section remains unchanged between the ingress interface and the egress interface. Various implementations of this method are described, including the use of the header compression context identifier (HCCID) by for routing the packets to the correct egress interface. Accordingly, a decompressor and a router are also disclosed.

### FIELD OF THE INVENTION

The present invention relates to a method for routing a data packet with a compressed header section, and to a method for routing a data packet with a header section from an originating network node to a destination network node through at least one intermediate router. It further relates to a decompressor device, a router device, and a communication network.

### BACKGROUND OF THE INVENTION

In communication networks using packet data transport, individual data packets carry information that is needed to transport the packet from a source application to a destination application in a header section. The actual data to be transmitted is contained in a payload section.

The transport path of a data packet from a source application to a destination application usually involves multiple intermediate steps represented by network nodes interconnected through communication links. These network nodes, called packet switches or routers, receive the data packet and forward it to a next intermediate router until a destination network node is reached that will deliver the payload of the data packet to the destination application. Due to contributions of different protocol layers to the transport of the data packet, the length of a header section of a data packet may even exceed the length of the payload section.

Data compression of the header section may therefore be employed to obtain better utilization of the link layer for delivering the payload to a destination application. Header compression is reducing the size of a header by removing header fields or by reducing the size of header fields. The term header field refers to an entry in the header containing a specified kind of information. For instance, a header field may contain the network address of the destination network node of the particular data packet.

Data compression in the header is done by coding the data in a way such that a decompressor can reconstruct the header if its context state is identical to the context state used when compressing the header. In general header compression works by occasionally sending a packet with a full header. Subsequent compressed headers refer to the context established by the full header and may contain incremental changes to the context.

Header compression may include the network layer, e.g., an Internet Protocol (IP) header, the transport layer, such as an User Datagram Protocol (UDP) header, a Transport Control Protocol (TCP) header, a Real-time Transport Protocol (RTP) header and even the application layer, such as a Hypertext Transport Protocol (http) header.

Access networks are typically built using copper cable or microwave radio transmission. In radio access networks, wireless communication links are provided to a source and/or destination station such as a mobile station, be it a mobile telephone or a mobile computer. Capacities of access networks are usually limited (e.g., N×E1 capacity). An extensive capacity upgrade and/or media change, e.g., to fiber, in an access network is very expensive for the operator. Therefore methods to save bandwidth in the access network are very important. Header compression is one such method.

On the transport path the routers involved need the routing information contained in the header to decide on the next router the data packet is forwarded to. Therefore, compressed headers are decompressed at an input port of an intermediate router before routing the packet based on the information contained in the header and a routing table maintained by the router. After routing the packet, the header is compressed again. The data packet is forwarded to an output port of the router, from where it is transmitted to the next router on the transport path.

However; compressing and decompressing the header in a router takes up processing capacity of that router. Regarding the end-to-end delay in the transport of a packet, the benefit of faster transmission of compressed header data due to the reduced header size may in part be outweighed by processing time needed to decompress and compress the header, especially at intermediate routers.

In Multi Protocol Label Switching (MPLS), such as described in the current version of Request for Comments (RFC) 3031, the entire set of possible packets to be received by a given router is partitioned into a set of “Forwarding Equivalence Classes” (FECs). All packets which belong to a particular FEC and which travel from that router will follow the same path. The assignment of a particular packet to a particular FEC is done once, as the packet enters the network. The FEC to which the packet is assigned is encoded as a short fixed length value known as a “label”. The packets are “labeled” before they are forwarded. When a packet is forwarded to its next hop, the label is sent along with it. At the next router, the label is used as an index into a table which specifies the following hop, and a new label. The old label is replaced with the new label, and the packet is forwarded to its next hop.

In MPLS forwarding, therefore, all forwarding is driven by the labels. This has the advantage that MPLS forwarding can be done by routers without analyzing the network-layer headers, or not capable of analyzing the network-layer headers at adequate speed. However, implementing support for MPLS is costly.

### SUMMARY OF THE INVENTION

It is therefore an object of the present invention to provide a simple method for routing a data packet with a compressed header section that reduces the processing load on the routers.

It is a further object of the present invention to provide a simple method for routing a data packet with a header section and a payload section from an originating, router to a destination router through at least one intermediate router that reduces the processing load on the routers.

It is a further object of the invention to provide a decompressor device allowing to reduce the processing load in the routing of a data packet in a router device.

It is a further object of the invention to provide a router device that causes only a short delay in the transmission of a data packet.

Finally, it is an object of the present invention to provide a communication network comprising a plurality of network nodes communicating with each other through a plurality communication links that allows for fast and reliable transmission of data packets even when packet loss cannot be excluded.

These objects are achieved by a method for routing a data packet with a compressed header section as claimed in claim 1, by a method for routing a data packet with a header section from an originating network node to a destination network node through at least one intermediate router as claimed in claim 29, by a decompressor device as claimed in claim 33, by a router device as claimed in claim 39, by a router device as claimed in claim 44 and by a communication network as claimed in claim 48.

According to a first independent aspect of the invention, a method for routing a data packet comprising a header section and a payload section is provided, said header section comprising a compressed header section containing coded information including routing information. The method comprises the following steps:
receiving said data packet at an input interface,
routing said data packet to an output interface,
forwarding said data packet to said output interface.

According to this method of the invention the routing step comprises ascertaining said routing information. Also, according to the invention, said coded information remains unchanged in said routing and forwarding steps.

Since the coded information remains the same in the routing and forwarding steps, the routing method of the invention allows to skip the (re)compression step performed by intermediate routers known in the art. Compression of a header section of a data packet needs only be performed at the originating network node. The originating network node making the header compression in the first place may for instance be an IP based node B and IP RNC according to the Third Generation Project Partnership (3GPP) release 5 standard, or any intermediate router on the transmission path.

Typically, compression consumes more time and processor capacity than decompression. Therefore, by leaving the information unchanged in the routing and forwarding steps, the compression step is unnecessary and the processor load in the intermediate router is reduced. Not having to do recompression also allows to reduce the delay caused by the routing of the data packet.

Note that leaving the information unchanged does not necessarily imply that the code containing the information in compressed form remains the same. According to the invention, different codes may be used for the same information. The term coded information also includes the case, where the code contains a reference to an information source, such as a line of a table, where the desired information can be ascertained.

According to the method of the invention, header fields, which according to existing standards are to be changed in every router, such as the time-to-live field (TTL), are either not part of the compressed header section. This way, they can be accessed without decompression and changed according to a predetermined rule, depending on the field. As an alternative, the complete header-compressed transmission path from source to destination is considered as one hop for the TTL count. Therefore, the TTL-field does not have to be changed during header-compressed transmission according to the method of the invention.

According to an embodiment of the method of the invention, the routing step comprises a step of reading header data from the compressed header section. This reading step allows the router to ascertain the information needed for a routing decision and contained in the compressed header section of an incoming packet. The compressed header section remains unchanged in this reading step.

According to a first preferred embodiment of the routing method of the invention said reading step comprises reading a header compression context identifier from the compressed header section. A header compression context identifier (HCCID) is a unique number identifying the header compression context that is used to decompress a compressed header. Therefore, the HCCID of an incoming data packet is coded routing information. It allows to ascertain the routing information by referring to a defined header compression context. The header compression context contains the routing information needed or allows to deduce it according to predetermined algorithms well known in the art.

The HCCID is carried as uncompressed data in full headers and headers with compressed header sections, hereinafter also called compressed headers. Therefore, the HCCID of an incoming data packet contains routing information that can be read from the header without performing a decompressing step. The HCCID need not necessarily be a part of the compressed header section. It may also be contained in an uncompressed section of the header. This embodiment has the advantage, that additional CPU capacity is saved that would otherwise be necessary for decompressing the compressed header section.

It is obvious that all header sections of a data packet may be compressed in the data packet to enhance the transportation speed of the packet. Routing information is contained in a network-layer header section. Therefore, this invention works with data packets containing a compressed network-layer header section or other additional compressed header sections or with data packets in which all header sections are compressed.

The header compression context may be described as the state which the compressor of the header or header section uses to compress, and the decompressor of this header or header section uses to decompress this header or header section. For an originating node the header compression context is the last uncompressed version of the header sent to the first intermediate router. In general, according to the invention, for the first and the following intermediate routers, the header compression context is the uncompressed version of the last full protocol header received over the link from the originating node or the previous intermediate router, respectively. According to the invention, intermediate routers do not need context information related to header sections of other layers, e.g., concerning a compressed transport layer header, such as a Transfer-Control Protocol (TCP) header, or a User Datagram Protocol (UDP)/Real-time Transport Protocol (RTP) header. The last full header received over the link contains all information needed for routing.

Therefore, according to the first preferred embodiment of the invention, intermediate routers may maintain a header compression context of reduced size, containing only a part of the full header. The reduced context must contain the information of the last uncompressed header that is necessary for correct IP routing, such as the IP destination address. It may also contain the IP source address and/or a service class. In contrast, header information not needed for IP routing, for example information from the mentioned User Datagram Protocol (UDP)/ Real-time Transport Protocol (RTP) header contained in the full header compression context, need not be maintained as part of the header compression context by intermediate routers for the purpose of the method of the invention.

There are several alternative ways to implement the present first preferred embodiment of the invention. When implementing the first preferred method of the invention, care has to be taken to assign unique header compression identification. This is not automatically the case, especially when compression is done over multiple links. The term multiple links refers to distributing IP traffic in the network in order to handle heavy traffic flows and reduce congestion. Multiple links may therefore be used for load balancing. The implementations of the method of the invention described in the following paragraphs each provide a way of assigning unique header compression context identifiers over a path having multiple hops and allowing for branching.

In the following, to avoid confusion, the term “implementation” is used with the same general meaning as “embodiment”. An embodiment will be named implementation if in addition to the features of a previously described embodiment it has further defining features.

Preferably, in a first implementation of the present first preferred embodiment of the invention said routing step comprises a step of assigning a second header compression context identifier to said data packet and a step of replacing said first header compression context identifier by said second header compression context identifier in said data packet. The second HCCID is hereinafter also named outgoing header compression context identifier (HCCID).

Each router performing the present implementation may use the complete space of possible HCCID values to assign an outgoing HCCID. For instance, the outgoing HCCID is one of a predetermined set of numbers. There is no need for assigning a certain subspace of HCCID values to each router in a network in this implementation in order to guarantee uniqueness of the HCCID. Uniqueness of the outgoing HCCID is guaranteed by the fact that the HCCID is defined by a given router performing the present implementation of the routing method for a given link and for a given header compression context.

The outgoing HCCID therefore unambiguously corresponds to one link between the router performing the routing method and an address for the next hop for the data packet to be forwarded, given the current header compression context. Accordingly, the data packet is forwarded to the output interface connecting the router performing the routing method to the network node of the next hop, be it another intermediate router or the destination network node. The HCCID of the incoming data packet is thus switched at each intermediate router of a transmission path.

A header compression context table and a switching table is created and maintained by each intermediate router in the transmission path. The header compression context table assigns to an incoming HCCID the current header compression context, i.e., the last full header in a particular flow. The switching table assigns to a first (incoming) HCCID contained in an incoming data packet a next-hop address or, respectively, an output port assigned to that next-hop address, and an outgoing HCCID.

Information needed for maintaining the switching table is taken from the current compression context table. In all known header compression methods the header compression context is maintained by letting a flow of data packets from a source to a destination network node occasionally contain packets with uncompressed headers. The same HCCID as in the compression context will be carried in the header of following incoming packets of that flow which have compressed headers, as long as they share the same header compression context. Once a new compression context is received, the HCCID is read from the context and the compression context table will be maintained. On the basis of the data in the compression context table an address of the next hop can be assigned to a given (incoming) HCCID.

The full header contains, among other data, a destination IP address and an (incoming) HCCID. These data are used to maintain the header compression context table. A new entry to the header compression context table is created for each new header compression context. The entry may be a line in the table with a plurality of columns, one for the HCCID, an additional column for each information element contained in the compression context, such as the source IP address, the destination IP address, and so forth. The number of columns is in the present implementation preferably restricted to the information elements necessary for routing purposes. This is the destination IP address, and, if supported, a service class identifier such as the DiffServ Code Point.

Maintenance of the header compression context table preferably also involves deleting unnecessary entries from the table to keep the table short and the used HCCID space small. This may be governed by a well known aging algorithm.

Maintaining the header compression context table triggers maintenance of the switching table. After routing a new compression context to an assigned output port the (incoming) HCCID of the data packet containing the context is replaced by an outgoing HCCID. A new entry in the switching table is created. This new entry is a line in the switching table with three columns, one for the incoming HCCID, one for the outgoing HCCID and one for the assigned output port or next-hop address, respectively.

Note that the steps of assigning an outgoing HCCID and replacing the incoming HCCID are performed for compressed headers as well as for uncompressed headers. Performing these steps in uncompressed headers is necessary to allow a following router in the transmission path to relate the HCCID it receives to the right compression context.

In order to provide an option for multiple links, the switching table may have a plurality of switching table entries, that may be assigned to one given incoming HCCID. Each switching table entry comprises an outgoing HCCID and a next-hop address/an output port which is different from that of the other entries assigned to the given incoming HCCID. Each possible assignment, therefore, is represented by an individual entry to the switching table. The actual assignment decision about the outgoing HCCID may be based on an input from a load balancing process run by the intermediate router. Such load balancing methods are well known in the art. Again, uniqueness of the outgoing HCCID is guaranteed by the fact that each link is assigned an individual HCCID.

Maintenance of the switching table may include an aging algorithm similar to that of learning switches. Especially, there may be a preset life time for entries to the switching table. A table entry may be erased after not having initiated a transmission within a certain time span, e.g., 5 minutes.

Routing information can thus be deduced from the incoming header compression context ID of a header-compressed packet alone. The deduced routing information may be temporarily attached to the packet inside the intermediate router, but before forwarding the data packet to the next router, the attached information is removed.

In a second, alternative implementation of the present first preferred embodiment of the invention, representing an independent solution for providing uniqueness of the HCCID, the HCCID space is partitioned such that each network node that may be a starting point of a header compressed transmission path manages an individual HCCID subspace. This subspace has no overlap with any other HCCID subspace managed by other network nodes. This may for instance be achieved by using an HCCID format that includes the IP address of the network node that is the starting point of the header compressed transmission path. It is well known that each network node using the Internet Protocol has a unique IP address. It has to be noted that due to the length of the IP address which is 16 octets in the coming version 6 of the Internet Protocol, the header compression performance is not optimal.

The HCCID of the present implementation contains a certain number of additional bits allowing to identify the particular header compression context from previous and later header compression contexts sent by that starting-point node. The originating network node making the header compression in the first place may for instance be an IP based node B and RNC according to the Third Generation Project Partnership (3GPP) release 5 standard, or any intermediate router on the transmission path.

Unique assignment of HCCID need not be based, as described above, on an IP network address of the starting point of the header-compressed path. Any other unique addressing system, or, more generally, any partition of a space of identifiers that gives each router, that first performs compression of a header, a set of “proprietary” identifiers which is sufficient with respect to the required transmission capacity of that router, will be in accordance with this method.

An aging algorithm may be implemented to allow to reuse the same HCCID after a predetermined time span with no transmission initiated using that HCCID.

This second implementation has the advantage that the switching table used by intermediate routers is simpler. There is no step of assigning an outgoing HCCID necessary in this method. The HCCID remains the same from the starting point to the end point of the header-compressed transmission path. The switching table used simply assigns an output port for the next hop to a given HCCID.

Uniqueness is also guaranteed for multiple links in this implementation due to fact that uniqueness of the HCCID is given in the whole network. Again, there are as many switching table entries as there are possible links for the next hop for a given HCCID. The routing decision is based on input from a load balancing algorithm.

A disadvantage of the present implementation is that the HCCID is necessarily longer than in the first implementation. The longer format of the HCCID is owed to the fact that uniqueness is not just guaranteed over a link but network-wide.

A second preferred embodiment of the routing method of the invention comprises, before said routing step, a step of decompressing routing information from said compressed header section.

In a first implementation of this second preferred embodiment the decompressing step comprises decompressing said complete compressed header section. This method has the advantage of making all compressed header information available for routing contained in the network-layer header section. However, in comparison with the first preferred embodiment it involves more processing effort to decompress the whole header section. Routing may be done in this implementation using conventional routing tables known in the art.

In a second implementation of this preferred embodiment, the decompressing step comprises decompressing a network layer address of a destination network node, such as an IP address. In addition, this implementation may comprise decompressing a service class identifier. This information will allow to assign an output port to the data packet in the routing step.

Due to the standardized format of the compressed header the exact position of the compressed data allowing to extract the destination network node address using the current compression context is known. Selective decompression of this section of the compressed header is therefore straight forward. It involves counting the header bits to a predetermined count number and copying a certain number of header bits from there on. It is noted that decompression in the present sense does not imply replacing or discarding any compressed information. The compressed header and, therefore, the routing information contained therein, remains unchanged in the routing and forwarding steps. This is achieved by selectively copying data from the compressed header and processing these copied data to obtain the desired decompressed data.

The decompressed header data, whether complete header or selected data, is not used to replace the compressed header. The decompressed data may, in a further embodiment of the method of the invention, be included at least partly into the data packet.

Inclusion of said decompressed header data is preferably done by attaching it to said data packet in front of said compressed header section, such that said decompressed header data can be forwarded to said egress interface before said compressed header section. This way, the decompressed information can be analyzed first for forwarding purposes.

In a further embodiment, a step of removing at least a part of said decompressed header data from said data packet is included before forwarding the data packet. Preferably, all decompressed header data is removed from the data packet.

In order to ensure quality of service, a further embodiment of the present invention includes provisions for differentiated services by comprising a step of classifying said data packet according to a service class. Such classification may be performed using the known Differentiated Services (DiffServ) scheme by assigning a DiffServ Code point (DSCP) to the data packet. This classifying step is preferably performed after said routing step. The classifying step preferably comprises a step of reading a service classification code element from a header compression context table. The right entry in the header compression context table is accessed using the HCCID introduced above or the network node identifier, also described above. The classifying step is preferably performed before said removing step.

The removing step comprises in a further embodiment removing said decompressed header data except for said service classification code element. However, carrying the service classification element between routers is not necessary. The service classifier may be removed before forwarding the data packet to the next router.

When providing differentiated services the forwarding step preferably comprises a step of placing said data packet into one of a plurality of queues, the chosen queue corresponding to a value of said classification code point. The service classification code element may be removed from the data packet before placing it in the assigned queue.

The present method of the invention is preferably applied in radio or microwave access networks, which due to the nature of the air interface offer limited bandwidth in serial transmission of data. It may also be used in any other access network, like copper-based access networks, e.g., Public Switched Telephone Networks (PSTN).

According to a second aspect of the invention the method of the invention as described so far is employed in a method for routing a data packet with a compressed header section from an originating node to a destination node through at least one intermediate router. This method comprises the steps of
a) at said originating router, routing said data packet to said intermediate router
b) at said originating router, compressing at least a part of said header section containing routing information
c) forwarding said data packet from said originating router to said intermediate router
d) at said intermediate router, which is communicating with said originating router through said input interface, performing a routing method as described above, said output interface communicating with a next intermediate router or said destination router, respectively,
e) repeating step d) for any further intermediate router,
f) at said destination router, decompressing said compressed network-layer header section
g) at said destination router, removing said compressed header section.

This method makes header compression doable for packet headers also in a narrow-bandwidth access networks over multiple links.

An embodiment of this method comprises a step of transmitting a header compression context from said originating router to said intermediate routers and to said destination router before performing the mentioned method steps.

A further embodiment comprises, at said originating router (A, 64), a step of assigning a header compression context identifier to said header compression context, and a step of including said header compression context identifier into said compressed header section.

According to a further aspect of the present invention a decompressor device is provided, comprising an input interface adapted to receive at least one data packet with compressed data, a decompressing means communicating with said input interface and adapted to decompress said compressed data such that decompressed data are created based on said compressed data, and an output interface communicating with said decompressing means and adapted to provide said decompressed data of said data packet. According to the present invention, the decompressing means is adapted to selectively decompress only compressed header data contained in a header section of said data packet.

The selectivity provided by the decompressor of the invention reduces the processing load in decompression of a header section of a data packet. In concentrating on data relevant for routing according to the methods described above the decompression becomes more effective and, thus, faster. By leaving all other data compressed a very fast timing performance can be achieved by this decompressor.

In a preferred embodiment of the decompressor device of the invention, the decompressing means has access to a header compression context table and is adapted to decompress said compressed data using data contained in at least one predetermined section of said header compression context table, and at least one predetermined decompression algorithm. Using the access to the header compression context table it is possible to deduce the uncompressed header data. Header compression often involves including only the difference between the data in the header compression context and the corresponding data in the present header in the compressed header section. By accessing the header context table the original data of the present header can be restored using simple mathematics.

According to a preferred embodiment of the decompressor of the invention the decompressing means is adapted to decompress from the compressed header section an identifier of an external network node that is the destination of the data packet.

According to a third preferred embodiment of the invention the decompressing means is adapted to decompress the complete compressed header section of the data packet. This way the full header information can be used. This advantage is paid for with a higher processing load.

According to an implementation of the first or second preferred embodiment the decompressing means is adapted to additionally decompress a service classification code element from said compressed header section. This allows a router the decompressor is connected to to perform the service classification and prioritization described above.

According to a further aspect of the invention a router device is provided, comprising at least one input port adapted to receive a data packet through at least one first communication link, and a plurality of output ports. The router device of the invention comprises at said input port a decompressor as described above.

The router device of the invention enables routing according to the methods described earlier. This provides fast and reliable routing also in an network environment with low-bandwidth links and in which packet loss cannot be excluded, such as in an IP RAN. The router of the invention is especially adapted to be embedded in IP RAN nodes such as an IP node B and IP RNC.

The router allows to do decompression of transport header data only in the middle of the IP access network header compressed transport, avoiding the need to compress again. Thus, CPU capacity is saved, especially in star points of a microwave access network. The decompression can also be reduced to a minimum using the decompressor described earlier, allowing a further reduction of CPU load.

The router is especially adapted to the role of an intermediate router. However, in a preferred embodiment the router of the invention is able to switch to the role of an originating or a terminating node in a transmission path as well. This may even be done on a per-flow basis, such that the router is an originating router for a first packet received belonging to a first flow at a first input port from a terminal device, an intermediate router for a second packet belonging to a second flow arriving at a second input port from a second router, and a terminating router for a third data packet belonging to a third flow received through a third input port from another router. However, the router may additionally also comprise an input port that is not equipped with a decompressor according to the invention. In a preferred embodiment of the router device of the invention, at least one input port further comprises attaching means communicating with said decompressor, and adapted to attaching to the data packet data received through said output of said decompressor. Thus, the attaching means produce an “intermediate” data packet which is forwarded in this state only within the router device. The decompressed data attached to the data packet will be used by the router device to perform the routing step.

Preferably, the attaching means is adapted to attaching said data to said data packet in front of the compressed header, such that said decompressed header data can be forwarded within the router device before said compressed header. This allows to analyze the decompressed header data before the whole extended data packet is received and/or stored.

In a further preferred embodiment, the router device of the invention comprises routing means communicating with said attaching means and with said output ports, and comprising lookup means adapted to determine, based on routing information contained in said data packet and based on a routing table, at least one destination output port, and forwarding means communicating with said routing means and adapted to forward said data packet to said determined output port.

A further embodiment of the router device of the invention further comprises removing means communicating with said lookup means and with said forwarding means, and adapted to remove from said data packet said decompressed data attached by said attaching means. This way, removal of the attached data is done before the data packet is passed through the switching fabric. This further increases the speed with which a data packet is forwarded through a router device. The delay in the transmission path of the data packet is reduced.

According to a further aspect of the invention a router device is provided for routing at least one data packet with a compressed header section, comprising at least one input port adapted to receive said data packet through at least one first communication link, and a plurality of output ports, wherein said input port comprises a reading unit adapted to read a first header compression context identifier from said compressed header section of said data packet, and a switching unit adapted to replace said first header compression context identifier by a second header compression identifier.

The present router device is especially designed to work according to the first implementation of the first preferred embodiment of the routing method of the invention, in which routing is based on the HCCID alone and the data packet receives a new outgoing HCCID unique for the link to the next hop.

In a preferred embodiment of this router device, said switching unit communicates with, i.e., has reading and/or writing access to a switching table that, as described in detail in context with the routing method, assigns to said first (incoming) header compression context identifier said second (outgoing) header compression context identifier and an output port identifier. The output port identifier is preferably a number uniquely assigned to one output port.

An implementation of the preferred embodiment has a control unit communicating with said reading unit and said switching table. The control unit is adapted to detect a new first header compression context identifier received at said reading unit, to assign a new second header compression context identifier and at least one output port identifier to said first header compression context identifier, and to create at least one entry in said switching table for said identifiers, one for each assignment of an output port. Multiple assignment of output ports is used for implementing multiple links functionality.

In a further implementation of said router device the control unit is additionally adapted to erasing said entry in said switching table given a predetermined condition, as described before in the context of the routing method with reference to aging.

Preferably, the invention is applied to a communication network, comprising a plurality of network nodes communicating with each other through a plurality communication links. By including network nodes with a router device according to the above description, the transmission speed in the network can be increased. Also the delay is reduced especially in networks including radio or microwave communication links. The invention is most preferably applied in a communication network using IP as a network layer protocol.

### BRIEF DESCRIPTION OF THE DRAWINGS

In the following, the present invention will be described in greater detail based on preferred embodiments with reference to the figures, in which:

FIG. 1 shows a block diagram of a decompressor;

FIG. 2 shows a block diagram of a router device according to a first preferred embodiment, including the decompressor of FIG. 1;

FIG. 2a shows a block diagram of an input unit of a router device according to a second preferred embodiment;

FIG. 3 shows a data packet as forwarded within the router of FIG. 2a;

FIG. 4 shows a network system with routers according to FIG. 2 or 2a;

FIG. 5 shows a flow diagram of a routing method implemented in the router of FIG. 2; and

FIG. 6 shows a flow diagram of a routing method implemented in the router of FIG. 2a.

### DESCRIPTION OF THE PREFERRED EMBODIMENT

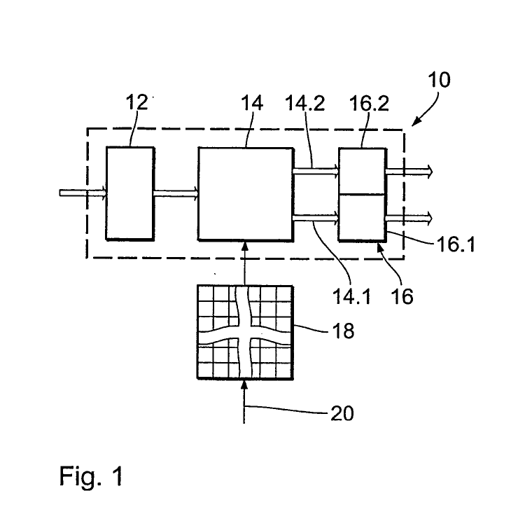

A preferred embodiment of the decompressor device of the invention will now be described on the basis of according to FIG. 1.

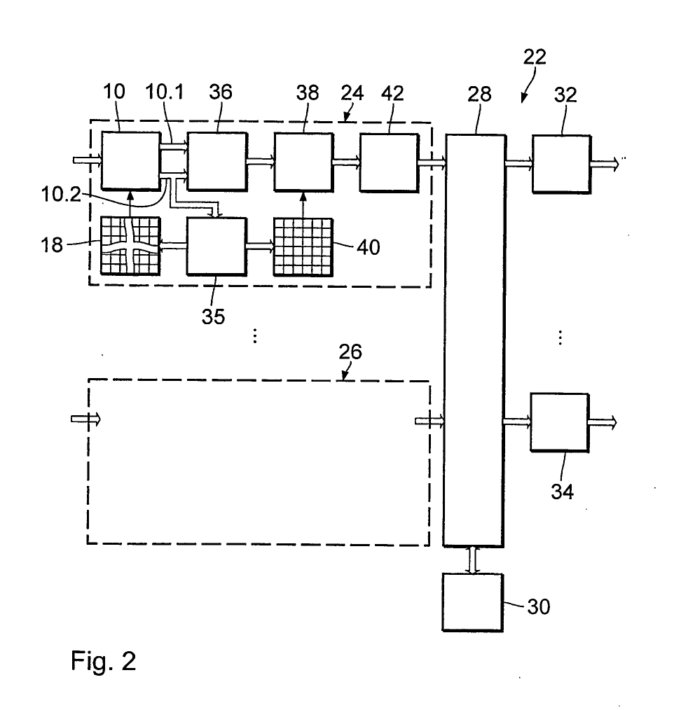

FIG. 1 shows a block diagram of a decompressor 10. The block diagram is simplified in order to only show the elements of relevance to the present invention. Accordingly, decompressor 10 comprises an input unit 12, a decompressing unit 14, and an output unit 16. Output unit 16 comprises a first output 16.1 for compressed packet data and a second output 16.2 for decompressed packet data. Decompressing unit 14 is connected for reading access to a header compression context table 18. To keep the functionality of decompressing unit 14 simple, header compression context table 18 is maintained at the current state by external units as will be seen below in the description of FIG. 2. This is indicated by an arrow 20.

Input unit 12 is adapted to receiving compressed data packets and forwarding them to decompressing unit 14. Input unit 12 may comprise several input interfaces (not shown) for use of the present decompressor as a central decompressor unit in a router with several input ports. In this case input unit 12 also comprised means to control the order of data packets forwarded to decompressing unit 14.

Decompressing unit 14 is adapted to receiving compressed data packets from input unit 12. The packets are decompressed by decompressing unit 14 according to a predetermined algorithm, or one of a plurality of predetermined decompression algorithms. For this, decompressing unit 14 accesses header compression context table 18.

Decompressing unit 14 only decompresses a predetermined header section depending on the routing mechanism of the invention to be used. Therefore, decompressing unit 14 has two output links 14.1 and 14.2 to output unit 16. The twofold output of decompressing unit 14 comprises the compressed data packet as received through input unit 12 over output link 14.1, and decompressed header data restored from the data packet, over output link 14.2.

Due to the compatibility of the decompression algorithm used by decompression unit 14 with the compression algorithm used by the router that created the compressed header of the received data packet, the position of the predetermined header section to be decompressed in the data flow received through input unit 12 is known. A counter (not shown) is preset upon the reception of a data packet in order to determine the correct bit position within the data packet received from said input port. Alternatively, where packet data is transported in parallel from input unit 12 to decompressing unit 14, the bit positions of the header section to be decompressed are predetermined in correspondence to the compression algorithm used.

Using the predetermined number of bits of the header section to be compressed and the information given by the header compression context table 18, header section data of the compressed header section are restored and forwarded to output 16.2 using output link 14.2.

The decompressor of FIG. 1 may be used to decompress any section of an incoming data packet. Decompressing unit 14 comprises a control unit (not shown) that determines which section of a data packet is to be decompressed. Decompression may comprise any number of bits, e.g., one bit, all bits of the compressed header section, or all bits of the data packet.

With reference to FIG. 2, in the following a preferred embodiment of a router 22 according to the invention will be described. Again, the block diagram of FIG. 2 serves only to explain the features relevant for the present invention.

Router 22 comprises a number of input ports, two of which are shown with reference numbers 24 and 26. A switching fabric 28 communicates with input ports 24 and 26, a routing processor 30 and a number of output ports, two of which are shown with reference numbers 32 and 34.

The following description focuses on the structure and function of input ports 24 and 26. While there is no structure shown in FIG. 2 for input port 26 it is the same as that of input port 24, and not shown here for reasons of simplicity only. Again, also the structure of input port 24 is simplified in order to show only those elements relevant in the context of the present invention.

Input port 24 comprises decompressor 10 communicating with an attachment unit 36. Attachment unit 36 is connected to a lookup unit 38 which is in turn connected to a routing table and a removing unit 42. Removing unit is also connected to switching fabric 28.

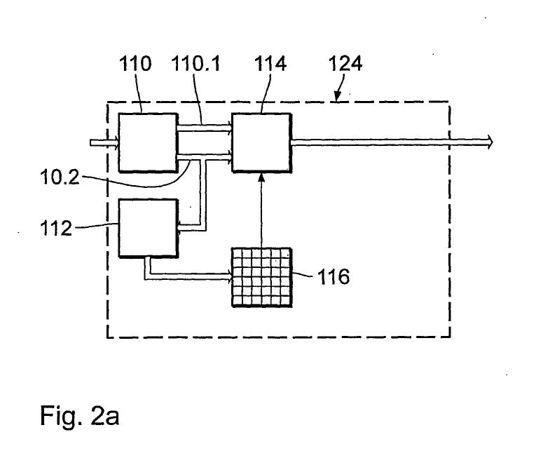

A data packet received at input port 24 will be processed by decompressor 10 as described above. Decompressed data and the header-compressed, unchanged data packet will be received by attachment unit 36 which attaches the received uncompressed data to the header-compressed data packet. The structure of the data packet that attachment unit 36 forwards to lookup unit 38 will be described below with reference to FIG. 3.

Lookup unit 38 performs the function that is central to the switching function of the router. A choice of an output port is made using information contained in routing table 40. Routing table 40 assigns output ports to header compression context identifiers (HCCID). Lookup unit 38, therefore, by looking up in routing table 40 determines the output port assigned to the HCCID extracted from the packet header by decompressor 10 and attached to the data packet by attachment unit 36. For example, the assigned output be 32. Routing table 40 is maintained on a regular basis by routing processor 30. It may also assign service classification information to the HCCID. The data packet is forward to the determined output port through switching circuit 28. Before entering switching circuit 28 all data attached to the data packet by attachment unit 36 are removed again. An exception is only made for the DiffServ Code Point (DSCP) which will be removed immediately before placing the data packet in an assigned queue (not shown) at the assigned output port 32.

FIG. 2b shows a block diagram of an input port of an alternative preferred embodiment of the router of the present invention. Only input port 124 of the router is shown because this is the only structural difference to the router of FIG. 2. Thus, replacing input ports 24 and 26 of FIG. 2 each by an input port 124 of FIG. 2a will result in a router device according to the present preferred embodiment.

Input port 124 comprises a reading unit 110. Reading unit 110 serially receives data packets. Reading unit 110 ascertains whether or not the header of the packet contains a compressed header section. It reads and copies a HCCID contained in each header-compressed packet. The HCCID is contained as uncompressed data in the packet header. The packet is forwarded to a switching unit 114 through a first link 110.1, which may be serial connection or, preferably, a parallel data bus.

The copied data is forwarded in parallel to a control unit 112 and to the switching unit 114 through a second link 110.2, which may be serial connection or, preferably, a parallel data bus.

Switching unit 114 refers to a switching table 116 for assigning an output port to the received data packet depending on the incoming HCCID and on the DSCP, and for replacing the incoming HCCID by an outgoing HCCID. The DSCP is available from the header compression context table. Switching table 116 has four columns, one for incoming HCCIDs, one for outgoing HCCIDs, one for the DSCP, and one for assigned output port identifiers. In case the TTL field is carried as uncompressed data in the packet, switching unit 114 will further decrement the TTL field value. The header-compressed packet will be forwarded to the assigned output port through switching fabric 28. It is noted that including the DSCP in the switching is optional.

In case there is no entry for the incoming HCCID in the switching table the incoming data packet will be a header compression context and therefore not contain compressed header sections. Switching unit 114 will perform regular routing for such uncompressed packets. It will assign an output port identifier and an outgoing HCCID to the packet. This assignment is made using the received destination and service class data and a routing table (not shown) which is based on a routing algorithm. The outgoing HCCID is written into the data packet in place of the incoming HCCID. The uncompressed packet will be forwarded to the assigned output port through switching fabric 28.

Switching unit 114 will forward the data quadruple containing the incoming and outgoing HCCID, the DSCP and the assigned output port identifier to control unit 112.

Control unit 112 will then create at least one entry in a switching table 116 for said identifiers, one entry for each assignment of an output port in case of support for multiple links.

With reference to FIG. 3, the structure of a data packet 44 that appears at the output of attachment unit 36 of FIG. 2 is shown. Data packet 44 comprises a payload section 46, a header section 48 and an attachment section 50. While payload section 46 comprises the data to be transported from the original application to the destination application, header section 48 includes a number of subheaders according to different protocol layers. Attachment section 50 comprises the decompressed header data that were attached to the data packet 44 by attachment unit 36.

FIG. 3 shows that the attached data appear at the very head of the data packet. This means that they are forwarded first to the lookup unit 38. There, the attached data may be immediately analyzed for lookup purposes such that routing can be done while the data packet is still being received by lookup unit 38.

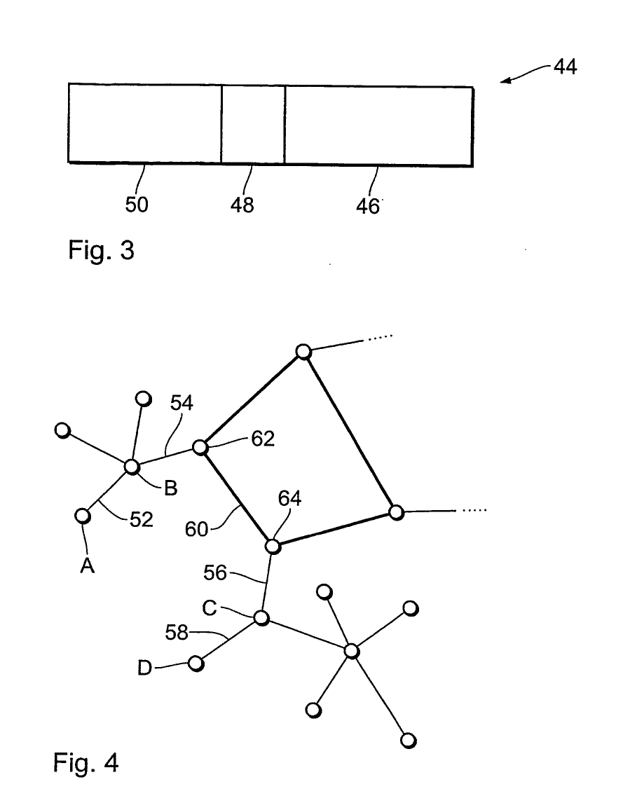

With reference to FIG. 4 an embodiment of the method of the invention will be described in more detail. FIG. 4 shows a network structure. Circles represent network nodes. For the purpose of the present description four access-network routers are shown with reference letters A, B, C and D. Two core-network routers are shown with reference numbers 62 and 64. Lines between circles represent communication links. Thin lines represent wireless links. Wireless links 52, 54, 56, and 58 are shown for the purpose of this description. Fat lines represent fiber links. Fiber link 60 between network nodes 62 and 64 is shown for the purpose of this description.

As an example, we assume that the header compressed transmission is done for a path comprising access-network nodes A, B, C, and D. Nodes A, B and C are routers. Node D need not be a router, if it is the destination of the packet. If not, D is a router. Routers A and 64 comprise a compressor performing header compression according to a predetermined algorithm. Router 62 and node D comprise a decompressor, performing header decompression according to a corresponding, predetermined decompression algorithm that allows to restore the original uncompressed header data.

First, a header compression context identifier is assigned to a given header compression context (HCC) in router A. The header compression context identifier (HCCID) is a unique number identifying the header compression context that is used to decompress a compressed header. The HCCID is carried in full headers and compressed headers. The HCCID can be a small number. Router A will forward the data packet to router B including in the compressed header section containing the HCCID.

There is no header compression in the core network. Therefore, router 62 is a first destination node for the header compressed flow. Router 64 is a second originating node for the header compressed flow to router D. A header compression context is created and maintained by each router in the transmission path from router A to router D. The HCCID is unique in each link, i.e., it has a unique value in router A for the link to router B pertaining to this header compression context, a different unique value in router B for the link to router 62, pertaining to this header compression context, and so on.

Router B uses the HCCID for routing the packets originating at router A on to router 62 without changing the compressed headers of the packets. No compression is used on the transmission path from router 62 to router 64. . For this, router B will create and maintain a switching table related to the particular input port in the following manner: after receiving the header compression context and the HCCID through a given input port from router A, a switching table entry is created in router B that assigns to the incoming HCCID the next hop, an output port for the next hop, and an outgoing HCCID.

When a packet with the incoming HCCID has arrived at this input port of router B, router B will look up the HCCID in the switching table. Then router B will pass the data packet through its switching fabric and forward the data packet to router C through the assigned output port. The compressed header of the data packet is not changed by router B. Router 62 will decompress the header and forward it on to router 64 using the routing information contained in the compressed header section.

Router 64 will act like router A. Router C will act like router B. After receiving the header compression context and the HCCID through a given input port from router 64, a switching table entry for this input port is created that assigns to the incoming HCCID a next hop, an output port for the next hop, and an outgoing HCCID. When a packet with the incoming HCCID has arrived at this input port of router C, it will look up the HCCID in the routing table and will pass the data packet through its switching fabric and forward the data packet to router D through the assigned output port. The compressed header of the data packet is not touched by router C.

Finally router D will decompress and remove the compressed header, attach the header to the payload of the data packet and rout the packet to the egress interface.

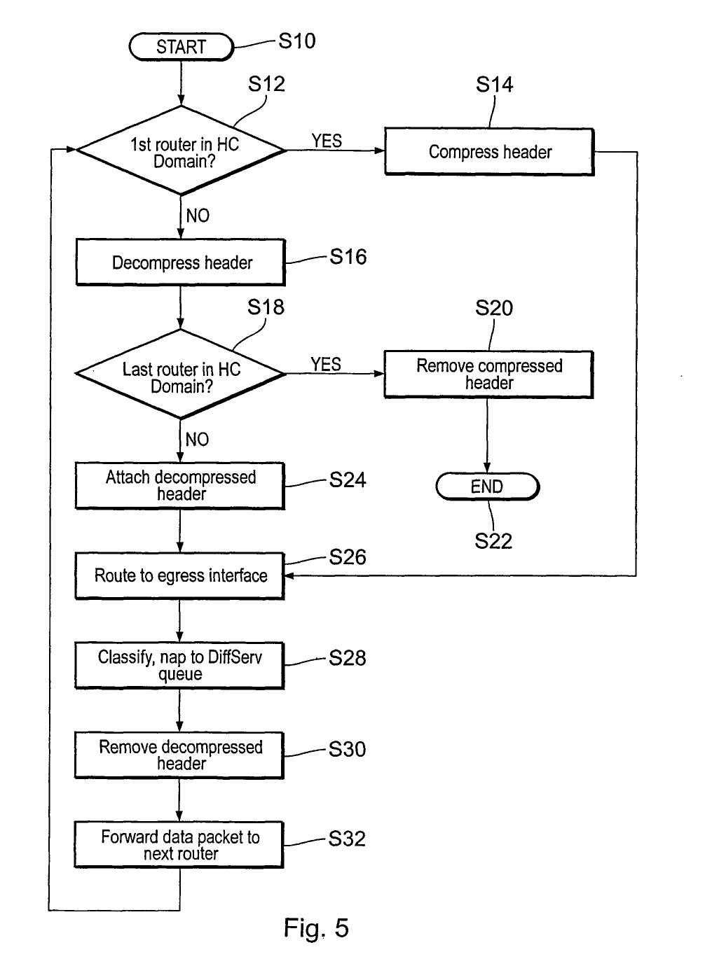

With reference to FIG. 5 a flow diagram of a routing method implemented in the router of FIG. 2 is shown. The routing method is started in a step S10 upon arrival of a data packet at an input port. In a step S12 the router checks if it is the first router in the header-compressed domain. If this is the case, i.e., the router has the role of router A of FIG. 4, the header of the data packet is compressed in a step S 14. After that step S26 is performed as will be described below.

If the router determines that it is not the first router in the header compressed domain, it will in a step S16 decompress a section of the header or the complete header, depending on the particular embodiment of the router, as explained above. For the present example, we assume that the whole header is decompressed. In a step S18 the router checks if it is the last router in the header-compressed domain. If this is the case the router will remove the compressed header in a step S20. Since no more routing is necessary the routing method is finished in a step S22.

However, if in step S18 the router determines that it is not the last router in the header-compressed domain, it attaches in a step S24 the decompressed header data to the data packet. In a step S26 it will route the packet to the correct egress interface.

Next, a classifying step S28 is performed in which the DSCP of the data packet is determined and the packet is assigned a corresponding queue at the assigned output port. The decompressed header data will then be removed from the data packet in a step S30. Finally, the data packet will be forwarded to the next router in a step S32. After this, the router waits for the next packet to switch back to step S12.

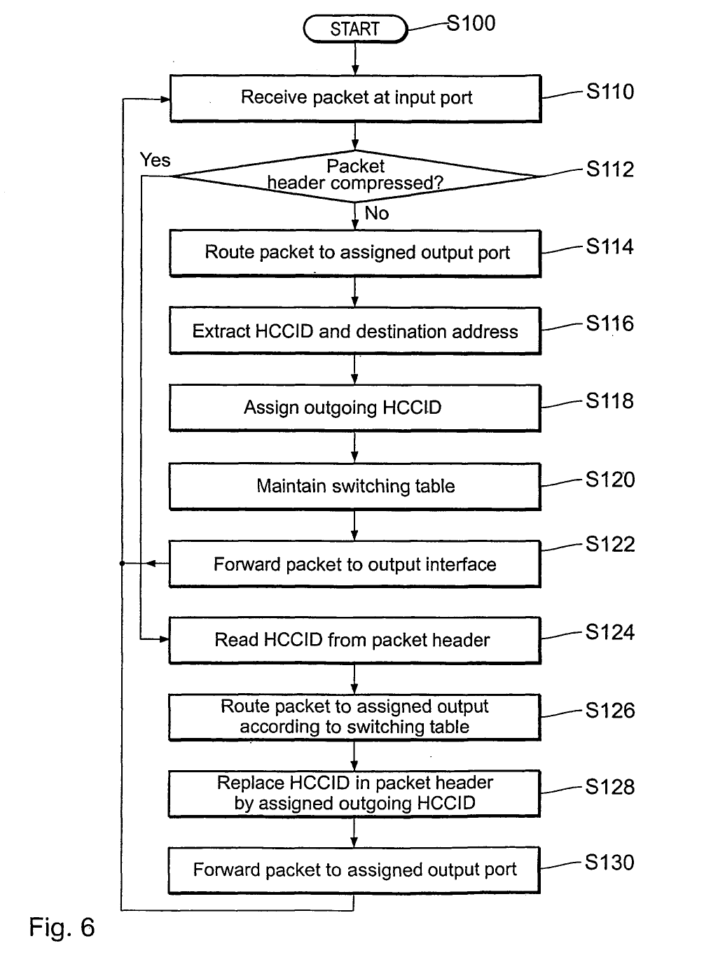

With reference to FIG. 6 a routing method will be described that is implemented in the router of FIG. 2a. The method is started in a step S100. In a following step S110 a data packet is received at an input port 110. If the received data packet does not contain a compressed header section, the packet is routed to an assigned output port. This assignment is based on a routing table. Further, HCCID and destination address are extracted, i.e., copied from the header, and an outgoing HCCID is assigned and written to the data packet, replacing the incoming HCCID (steps 116 and S118). In a step S120 the switching table is maintained by creating an entry for the new incoming HCCID, as described with reference to FIG. 2a. The packet is then forwarded to the assigned output port.

If in step S112 it is ascertained that the packet does contain a compressed header the method continues at step S124 with reading the incoming HCCID from the packet header. The packet will at step S126 be routed to the assigned output port according to the pertaining switching table entry. Then, the HCCID will be replaced in the packet header by the assigned outgoing HCCID in step S128. Finally, the packet will be forwarded to the assigned output port.

Application of the invention is especially considered for RTP/UDP/IP and UDP/IP header compression.

1. A method for routing a data packet comprising a header section and a pay-load section, said header section comprising a compressed header section containing coded information including routing information, comprising the steps of:
receiving said data packet at an input interface
routing said data packet to an output interface
forwarding said data packet to said output interface, wherein said routing step comprises ascertaining said routing information from said compressed header section, and wherein said coded information is left unchanged in said routing and forwarding steps.

2. A method according to claim 1, wherein said ascertaining step comprises a step of reading a first header compression context identifier from said com- pressed header section.

3. A method according to claim 1, wherein said routing step comprises a step of assigning a second header compression context identifier to said data packet and a step of-replacing said first header compression context identifier by said second header compression context identifier in said data packet.

4. A method according to claim 3, wherein said second header compression context identifier is one of a predetermined set of numbers.

5. A method according to claim 3, wherein said assigning step comprises a step of looking up said second header compression context identifier in a switching table, said switching table uniquely assigning to said first header compression context identifier said second header compression identifier and one of a plurality of output interfaces.

6. A method according to claim 5, further comprising a step of maintaining said switching table.

7. A method according to claim 6, wherein said maintaining step comprises receiving and saving an incoming header compression context.

8. A method according to claim 7, wherein said maintaining step further comprises reading said first header compression context identifier and a destination address from said header compression context.

9. A method according to claim 8, wherein said maintaining step further comprises assigning one of a plurality of output interfaces to said first header compression context identifier based on a routing table, said routing table assigning said output interface to said destination address.

10. A method according to claim 9, wherein said maintaining step further comprises a step of assigning said second header compression context identifier to said first header compression context identifier.

11. A method according to claim 10, wherein said maintaining step further comprises a step of creating a new entry in said switching table for each incoming header compression context, said entry comprising said first header compression context identifier, said second header compression context identifier, and said output port.

12. A method according to claim 6, wherein said maintaining step comprises a step of erasing an entry from said switching table given a predetermined condition.

13. A method according to claim 1, comprising, before said routing step, a step of decompressing said routing information from said compressed header section.

14. A method according to claim 13 wherein said decompressing step comprises decompressing said complete compressed header section.

15. A method according to claim 13, wherein said decompressing step comprises decompressing an address of a destination network node.

16. A method according to claim 13, wherein said decompressing step comprises decompressing a service classification code element.

17. A method according to claim 13, comprising, after said decompressing step, a step of including at least a part of said decompressed header section into said data packet.

18. A method according to claim 17, wherein said part of said decompressed header is attached to said data packet in front of said header section, such that said part of said decompressed header can be forwarded before said header section.

19. A method according to claim 17, comprising, a step of removing at least a part of said decompressed header from said data packet.

20. A method according to claim 19, wherein said removing step is performed after said routing step.

21. A method according to claim 2, comprising a step of classifying said data packet according to a service class.

22. A method according to claim 21, wherein said classifying step is performed after said routing step.

23. A method according to claim 21, wherein said classifying step comprises a step of reading a service classification code element from a header compression context table.

24. A method according to claim 22, wherein said classifying step is performed before said removing step.

25. A method according to claim 19, wherein said removing step comprises removing said decompressed header data except for said service classification code element.

26. A method according to claim 21, wherein said forwarding step comprises a step of placing said data packet into one of a plurality of queues, the chosen queue corresponding to a value of said classification code point.

27. A method according to claim 25, comprising a step of removing said service classification code element before said placing step.

28. A method according to claim 1, wherein said forwarding step comprises radio or microwave transmission of said data packet.

29. A method for routing a data packet with a header section and a payload section from an originating router to a destination router through at least one intermediate router, comprising the steps of
a) at said originating router, routing said data packet to said intermediate router
b) at said originating router, compressing at least a part of said header section containing routing information
c) forwarding said data packet from said originating router to said intermediate router
d) at said intermediate router, which is communicating with said originating router through said input interface, performing a routing method according to claim 1, said output interface communicating with a next intermediate router or said destination router, respectively,
e) repeating step d) for any further intermediate router,
f) at said destination router, decompressing said compressed header section
g) at said destination router, removing said compressed header section.

30. A method according to claim 29, comprising a step of transmitting a header compression context from said originating router to said intermediate routers and to said destination router before performing the method steps of claim 29.

31. A method according to claim 30, comprising, at said originating router, a step of assigning a header compression context identifier to said header compression context, and a step of including said header compression context identifier into said compressed header section.

32. A method according to claim 31, wherein said header compression context identifier contains a network address of said originating router.

33. A decompressor device, comprising an input interface adapted to receive at least one data packet containing compressed data, a decompressing means communicating with said input interface and adapted to decompress said compressed data such that decompressed data are created based on said compressed data, and an output interface communicating with said decompressing means and adapted to provide said decompressed data of said data packet, wherein said decompressing means is adapted to selectively decompress only compressed header data contained in a header section of said data packet.

34. A decompressor device according to claim 33, wherein said decompressing means has access to a header compression context table and is adapted to decompress said compressed data using data contained in at least one predetermined section of said header compression context table, and/or using at least one predetermined mathematical decompression rule.

35. A decompressor device according to claim 33, wherein said decompressing means is adapted to decompress from said compressed header section an identifier of an external network node that is the destination of said data packet.

36. A decompressor device according to claim 35, wherein said decompressing means is adapted to decompress only said identifier of said network node that is the destination of said data packet.

37. A decompressor device according to claim 33, wherein said decompressing means is adapted to decompress said complete compressed header section of said data packet.

38. A decompressor device according to claim 33, wherein said decompressing means is adapted to decompress a service classification code element from said compressed header section.

39. A router device, comprising at least one input port adapted to receive a data packet through at least one-first communication link, and a plurality of output ports, wherein said input port comprises a decompressor according to claim 33.

40. A router device according to claim 39, wherein said input port further comprises attaching means communicating with said decompressor and adapted to attaching to said data packet data received through said output of said decompressor.

41. A router device according to claim 40, wherein said attaching means is adapted to attaching said data to said data packet in front of said header section, such that said decompressed header data can be forwarded before said header.

42. A router device according to claim 39, further comprising routing means communicating with said attaching means and with said output ports, and comprising lookup means adapted to determine, based on routing information contained in said data packet and based on information contained in a routing table, at least one destination output port, and forwarding means communicating with said routing means and adapted to forward said data packet to said determined output port.

43. A router device according to claim 42, wherein said routing means further comprises or communicates with removing means communicating with said lookup means and with said forwarding means, said removing means being adapted to remove from said data packet said decompressed data attached by said attaching means.

44. A router device for routing at least one data packet with a compressed header section, comprising at least one input port adapted to receive said data packet through at least one first communication link, and a plurality of output ports, wherein said input port comprises a reading unit adapted to read a first header compression context identifier from said compressed header section, and a switching unit adapted to replace said first header compression context identifier by a second header compression identifier.

45. A router device according to claim 44, wherein said switching unit communicates with a switching table assigning to said first header compression context identifier said second header compression context identifier and at least one output port identifier.

46. A router device according to claim 45, further comprising a control unit communicating with said reading unit and said switching table, and adapted to detect a new first header compression context identifier received at said reading unit, to assign a new second header compression context identifier and an output port identifier to said first header compression context identifier, and to create at least one entry in said switching table for said identifiers, one entry for each assignment of an output port.

47. A router device according to claim 46, wherein said control unit is additionally adapted to erase said entry in said switching table given a predetermined condition.

48. A communication network, comprising a plurality of network nodes communicating with each other through a plurality communication links, characterized in that said communication network comprises a network node with a router device according to claim 39.

49. A communication network according to claim 48, wherein at least a part of said communication links is a radio or microwave communication link.

50. A communication network according to claim 48, wherein said network nodes use an Internet Protocol as a network layer protocol.
